(19) United States
(12) Patent Application Publication
(10) Pub. No.: US 2009/0226041 A1
(43) Pub. Date: Sep. 10, 2009

(54) Method and Apparatus for Object Localization From Multiple Bearing Lines

(75) Inventor: Wieslaw Jerzy Szajnowski, Guildford (GB)

Correspondence Address: BIRCH STEWART KOLASCH & BIRCH, PO BOX 747, FALLS CHURCH, VA, 22040-0747, US

(73) Assignee: Mitsubishi Kenki kabushiki Kaisha, Tokyo (JP)

(21) Appl. No.: 12/225,533

(22) PCT Filed: Mar. 27, 2007
(86) PCT No.: PCT/GB2007/001096

§ 371 Date: Mar. 23, 2009

(30) Foreign Application Priority Data
Mar. 31, 2006 (EP) 06251803.0

(51) Int. Cl. G06K 9/00

(52) U.S. Cl. 382/106

(57) ABSTRACT

A method of determining the location of an object uses data representing the bearing of the object from a plurality of observation locations. The method comprises (a) deriving, for each bearing, the coordinates of a point, the coordinates comprising a first value p representing the signed distance between a predetermined location and the closest point on the bearing line, and a second value θ representing the angle of the bearing line, using a procedure according to which co-linear bearings of opposite direction have first values which are of opposite sign to each other and second values which differ from each other by π; and (b) deriving parameters defining a curve fitting said points, said parameters representing the object location. Values representing the signal-to-noise ratios associated with the bearing measurements, and values representing the observation locations relative to each other and to the object, can be used to group the bearings for the purpose of weighting their effects on the calculation of object location.

### BACKGROUND OF THE INVENTION

1. Field of the Invention

This invention relates to a method and apparatus for determining an unknown location of an object from bearing lines supplied by multiple sensors distributed over some surveillance region of interest, and is especially, but not exclusively, applicable to dynamically reconfigurable networks of distributed sensors.

2. Description of the Prior Art

There are many circumstances in which there is a need to detect, localize and track a noncooperative object of interest in some specified surveillance area. Such tasks can be performed by suitable active or passive sensors which can extract useful information by collaborative processing of signals reflected or emitted by that object.

In contrast to applications employing active sensors, such as radar or active sonar, in which the surveillance region of interest is illuminated by an interrogating energy waveform to obtain object-backscattered returns, passive sensors capture only object-generated signals. For example, the movement of people, wheeled or tracked vehicles, speedboats, vibrating machinery can all generate usable acoustic signals, which can be exploited for object detection, localization and tracking.

One area in which object detection and localisation is useful is that of security surveillance with a network of distributed optical and/or acoustic sensors. When an object of interest, such as a vehicle, has been detected and localised, the estimated object position can be utilized by security cameras for aiming and zooming, in order to enhance the quality of recorded images. Such systems may be installed for monitoring purposes in industrial environments, e.g. to offer improved continuous surveillance of critical infrastructure, including power grids, power plants, gas and oil pipelines and water supply systems.

Another application is that of coastguard or littoral surveillance in which speedboats and other surface vessels of interest can be detected and localized by a network of floating buoys employing acoustic sensors and low-power radio transceivers providing an intersensor communication link.

One important application in which the present invention can be utilized is that of bearings-only object localization by a wireless network of unattended ground sensors (UGS) employed to provide an improved security surveillance capability. The network comprises a plurality of passive sensors, dispersed over some surveillance region of interest, and a data fusion centre. The sensors that form the nodes of the network may be of the same type (e.g., all optical, infra-red, acoustic, seismic, etc.), or the network may employ disparate sensors. It is assumed that there is provided a radio frequency (RF) link to exchange information between the sensors and the data fusion centre. The main task of the sensor network is to detect the presence of an object of interest and to determine its location.

FIG. 1 is an example of a sensor network comprising a plurality of sensors, S1, S2, . . . , Sk, . . . , SM, arranged in a regular or irregular array, and a data fusion centre DFC. Each sensor is capable of detecting the presence of an object and determining a bearing angle (or direction of arrival, DOA) of a signal emitted by that object. The data fusion centre DFC may ‘interrogate’ either all the sensors or only a group of sensors selected in a judicious manner to supply bearing information. The bearing information is then suitably processed in the DFC to determine the ‘snapshot’ coordinates (x₀,y₀) of the object location P₀. The DFC may also incorporate a subsystem with tracking capabilities, such as an extended Kalman filter, a particle filter or other similar device.

A well-known class of algorithms for beaings-only object localization is based on modelling each observed bearing angle φₖ* as

φₖ*=φₖ+ηₖ, k=1, 2, . . . M

where φₖ is the true bearing angle given by

$${φ}_{k} = arc tan ( \frac{{y}_{0} - {y}_{Sk}}{{x}_{0} - {x}_{Sk}} )$$

where (x₀,y₀) are hypothesized coordinates of the object location, (x_{Sk},y_{Sk}) are known coordinates of the k-th sensor Sk, and ηₖ is the observation error with zero mean and variance σₖ².

The estimated object location (x₀*,y₀*) is a pair of such numbers (x₀,y₀) for which the following expression

$${\sum }_{k = 1}^{M} \frac{{( {φ}_{k} - {φ}_{k}^{⋆} )}^{2}}{{σ}_{k}^{2}}$$

attains its minimum value.

Other known algorithms of this class may attempt to minimize somewhat modified versions of the above cost function, but all the algorithms will suffer to some extent from the following drawbacks:
1. there is no indication of whether or not the ‘viewing’ geometry is favourable, e.g. whether the problem is ill-conditioned because the bearing lines are almost co-linear;
2. there is no guarantee that the global minimum has been reached; hence the determined location may differ significantly from the true one;
3. the implementation is based on iterative batch processing rather than recursive processing which, in general, is much more suitable for real-time implementation.

It would therefore be desirable to provide a method and an apparatus for object localization in a more efficient way than that provided by the prior art techniques, especially (but not only) for dynamically reconfigurable networks of distributed passive sensors with limited computation and communication capabilities.

### SUMMARY OF THE INVENTION

Aspects of the present invention are set out in the accompanying claims.

Some aspects of the invention use techniques which involve mapping a set of bearing lines into points which will theoretically, as a consequence of the mapping procedure, lie on a cosine curve (which term is used herein as synonymous with sine curve). The position of the object to be localised will determine the phase and amplitude of the cosine curve. Accordingly, the location of the object can be determined by finding the phase and amplitude of the cosine curve substantially fitting the points, which can be achieved in a efficient manner, for example using known curve-fitting algorithms. Preferably the parameters of the cosine curve are determined by combining the coordinates of the points in a particular manner, preferably using various averages. A particularly preferred embodiment described below uses a technique analogous to quadrature demodulation in signal processing to extract orthogonal components of mapped bearing lines and then combines the components to derive the Cartesian coordinates of the object location.

The principle of operation of the preferred embodiments is described below.

In stochastic geometry, it is known that a directed line b (e.g., a bearing line emanating from a sensor) may be characterized by two parameters d and β, where d is the perpendicular (signed) distance of b from a reference location or point (e.g. an origin 0), and β is an angle, measured in an anti-clockwise direction, between the line b and a reference directed line such as an x axis, north or other direction. The parameter d is positive if the reference point lies to the left of the line, as we ‘look along it’, and d is negative if the reference point lies to the right of the line. FIG. 2 depicts examples of bearing lines, including two lines (b1 and b2) that are anti-parallel.

Each directed line b in the xy-plane is determined uniquely by a corresponding pair of parameters (d, β); in other words, there is one-to-one correspondence between all directed lines {bk} in the xy-plane and the points {(dₖ,βₖ)} on the infinite cylinder, defined by

{(d,β):−∞<d≦∞,0≦β<2π}

Accordingly, the infinite cylinder with unit radius determines the (d,β)-space which includes all directed planar lines.

As known from stochastic geometry, when the (d,β) parameterisation is used to represent lines on a plane, the probabilistic characterization of the lines is invariant under the group of rigid motions (translations and rotations) in the plane. Therefore, for the purpose of object localization and tracking such parameterisation is superior to other parameterisations, such as the slope-intercept one, used in other applications.

A preferred and independent aspect of the invention operates according to the following principles, although it should be noted that particular embodiments of the invention may not perform the actual steps as described, but may instead operate using equivalent techniques.

For the purpose of object localisation it is convenient to transform the (d,β)-space of bearing lines into an equivalent (p,θ)-space as follows. Let (x₀,y₀) be the coordinates of a stationary point P₀ to be localized, and let bk be any bearing line, from any sensor Sₖ, passing through P₀, as shown in FIG. 3. By construction,

pₖ=r₀ cos(θₖ−α₀) (1)

where θ is the angle that the perpendicular pₖ makes with the x-axis, and r₀ and α₀ are the polar coordinates

$${r}_{0} = \sqrt{{x}_{0}^{2} + {y}_{0}^{2}} , {α}_{0} = arctan ( \frac{{y}_{0}}{{x}_{0}} )$$

of the point P₀.

When the value of angle θ is allowed to vary over the entire (0, 2π)-range, equation (1) will represent all bearing lines passing through the point P₀. For illustrative purposes, FIG. 4 depicts examples of bearing lines passing through P₀; lines, b1, b2 and b4, are undirected, whereas lines b3⁺ and b3⁻ have opposite direction.

Equation (1) may alternately be viewed as a unique representation of the point P₀ on the surface of an infinite cylinder with unit radius:

{(p,θ):−√<p<∞,0≦θ<2π}

From those two interpretations of equation (1) it follows that each point P(x,y) in the xy-plane will be represented by a respective ellipse obtained by cutting the unit-radius cylinder by a plane, as shown in FIG. 5a. In particular, polar coordinates, r₀ and α₀, of a specified point P₀ can be determined from the elevation angle ψ, as r₀=tan ψ, and from the azimuth angle α₀. All bearing lines passing through the point P₀ are represented by points on the ellipse. For example, the directed bearing lines b3⁺ and b3⁻ shown in FIG. 4 appear as corresponding points b3⁺ and b3⁻.

In accordance with the adopted parameterisation, to each undirected bearing line in the xy-plane, such as lines b1, b2 and b4 shown in FIG. 4, there corresponds a pair of points lying on the ellipse. These pairs of points, such as: b1⁺ and b1⁻, b2⁺ and b2⁻, b⁴⁺ and b4⁻, are reflections of each other. As seen from FIG. 5a, as the line direction changes, the point jumps to the opposite wall of the cylinder, while the value of the p-parameter changes its sign.

When the surface of the cylinder is unfolded, the ellipse appears as one cycle of a cosine wave, as shown in FIG. 5b. While the period of the cosine wave is equal to 2π, the amplitude r₀ and starting phase as are equal to the respective polar coordinates, r₀ and α₀, of the point P₀. Two points representing opposite directions of a bearing line passing through P₀ are shifted (cyclically) on the cosine wave with respect to each other by π. Although the p-coordinates of these points have equal magnitudes, each of them retains the sign of the corresponding direction of the bearing line. When there are no observation errors, each point of the pair carries the same information as the other one.

The problem of determining the unknown object location (x₀, y₀) in the (x,y)-plane from a plurality of bearing lines {bk}, supplied by respective sensors {Sk}, is reduced to fitting in a (p,θ)-space a cosine wave with known period (but unknown amplitude and phase) to a plurality of points, where each such point represents a respective bearing line. More specifically, the unknown amplitude r₀ and the unknown phase α₀ define the cosine wave to be fitted and are equal to the respective polar coordinates of the point to be localized.

Because in practice each bearing line bk is corrupted by some measurement error, the coordinates (pₖ,θₖ) of the corresponding point on the surface of the cylinder will be perturbed. Consequently, the task of fitting a sine wave to a plurality of given points is far from being trivial. In principle, any suitable robust numerical algorithm can be utilized for this purpose. However, in the preferred embodiments of the invention described below the parameters representing the multiple bearing lines are processed using techniques which offer the following advantages:
the method is based on a closed-form solution to the problem; hence no iterative computation steps are needed;
the method can utilize input data in a recursive manner to perform object localization and facilitate tracking;
the method provides a measure indicative of the ‘goodness of viewing geometry’; therefore it can be utilized for selecting a group of sensors that can perform object localization in a most efficient manner;
the method can be made sufficiently robust to process input data corrupted by noise and other interference;
for most applications, the method can be implemented in real-time even with a standard digital signal processor (DSP) or a suitable low-complexity FPGA.

In implementing these preferred techniques, a bearing angle βₖ provided by sensor Sk is used together with known sensor coordinates (x_{Sk},y_{Sk}) to determine the parameters (pₖ,θₖ) of a point representing the corresponding bearing line bk in the (pₖ,θₖ)-space. The values of θₖ and pₖ are obtained from

θₖ=βₖ−π2, pₖ=x_{Sk} cos θₖ+y_{Sk} sin θₖ, k=1, 2, . . . , M (2)

It is to be noted that θₖ could be any value within the range (0, 2π), depending on the direction of the bearing, and pₖ can be either negative or positive, depending on both the direction of the bearing and the position of the closest point on the bearing line relative to the reference location.

The parameter pₖ has normalized components (which can also have positive and negative values), which can be derived by resolving each parameter pₖ at the corresponding angle θₖ using orthogonal trigonometric functions, in this case sin θₖ and cos θₖ. Thus, averages Q and I of these components are determined as follows:

$$Q \underline{Δ} \frac{1}{M} {\sum }_{k = 1}^{M} {p}_{k} sin {θ}_{k} , I \underline{Δ} \frac{1}{M} {\sum }_{k = 1}^{M} {p}_{k} cos {θ}_{k} \qquad ( 3 )$$

It can be seen from FIG. 3 that

pₖ=r₀ cos(θₖ−α₀), k=1, 2, . . . M, 0≦θ<2π

Hence:

pₖ=r₀(sin θₖ sin α₀+cos θₖ cos α₀)

Thus:

pₖ=r₀ sin α₀ sin θₖ+r₀ cos α₀ cos θₖ=y₀ sin θₖ+x₀ cos θₖ

The averages Q and I can thus be expressed as

$$Q = \frac{{y}_{0}}{M} {\sum }_{k = 1}^{M} {sin}^{2} {θ}_{k} + \frac{{x}_{0}}{M} {\sum }_{k = 1}^{M} sin {θ}_{k} cos {θ}_{k}$$

$$I = \frac{{x}_{0}}{M} {\sum }_{k = 1}^{M} {cos}^{2} {θ}_{k} + \frac{{y}_{0}}{M} {\sum }_{k = 1}^{M} sin {θ}_{k} cos {θ}_{k}$$

Assuming S, C, and P are the auxiliary averages defined as follows

$$\begin{matrix}S \underline{Δ} \frac{1}{M} {\sum }_{k = 1}^{M} {sin}^{2} {θ}_{k} , C \underline{Δ} \frac{1}{M} {\sum }_{k = 1}^{M} {cos}^{2} {θ}_{k} & ( 4 ) \\ P \underline{Δ} \frac{1}{M} {\sum }_{k = 1}^{M} sin {θ}_{k} cos {θ}_{k} & ( 5 )\end{matrix}$$

then Q and I can be expressed as

Q=Px₀+Sy₀

I=Cx₀+Py₀

Consequently, the Cartesian coordinates, x₀ and y₀, of a point P₀ at which all the M bearing lines {bk}={(pₖ, θₖ); k=1, 2, . . . , M} intersect can be determined from the following two linear equations

Px+Sy−Q=0 (6)

Cx+Py−I=0 (7)

The two lines, given by equations (6) and (7), may be viewed as two metabearing lines: Q-line and I-line. Their intersection yields the Cartesian coordinates

$${x}_{0} = \frac{IS - QP}{SC - {P}^{2}} , {y}_{0} = \frac{QC - IP}{SC - {P}^{2}} \qquad ( 8 )$$

of the point P₀ at which all the M bearing lines intersect.

The values x₀, y₀ uniquely define the polar coordinates r₀, α₀ of the point P₀, and thus, as can be seen from the foregoing, are parameters defining the cosine wave to be fitted to the points representing the bearing lines.

The orthogonal functions sin θₖ and cos θₖ resolve the parameter pₖ into components which correspond to directions parallel to the Cartesian x and y axes, with the x axis aligned with the reference direction. This is preferred but not essential. The values θₖ could be adjusted, to resolve the parameter pₖ into components which are rotated relative to the reference direction.

Instead of using averages of the various parameters mentioned above, other quantities (such as sums) which are proportional to the averages may be used. The parameters may also be combined in other ways, such as by taking a trimmed or weighted average, the median value, etc.

Because the two intersecting metabearing lines, Q-line and I-line, encapsulate information concerning the ‘viewing’ geometry of the M bearing lines, it is of interest to determine the angle between these lines. The acute angle ξ between the lines can be obtained from

$$ξ = arctan \vert \frac{SC - {P}^{2}}{P} \vert \qquad ( 9 )$$

As an example, FIG. 6 shows the four bearing lines of FIG. 4 and the angle ξ between the resulting two metabearing lines, Q-line and I-line.

The ‘viewing’ geometry representing the relationship between the bearing lines (i.e. the positions of the observation locations relative to each other and to the object) becomes more and more favourable when the value of the angle ξ is changing from zero (coinciding or co-linear metabearing lines) to π/2 (perpendicular metabearing lines). Preferred embodiments of the invention are arranged to calculate this value, so that an indication of the quality of the estimate of the object location can be generated and/or the sensor outputs can be selectively processed in order to improve the quality.

The Q-line and the I-line can also be regarded as a result of applying a data compression procedure to M bearing lines in order to obtain just two metabearing lines (i.e., compression ratio being equal to M/2).

The mapping procedure discussed above is preferred but not essential. For example, it would be possible to use a mapping procedure whereby θₖ varies between 0 and π, or where pₖ is always positive (or negative). Because of the periodicity and symmetry of cosine curves, the phase and amplitude of the cosine curve would still be determinable.

The above method can be utilized to develop various embodiments of a topologic correlator which may be incorporated into a data fusion centre to process efficiently bearing information supplied by a plurality of passive sensors. Some illustrative examples of topologic correlators constructed in accordance with the invention are presented below.

In some embodiments of the invention, the data provided by the various sensors is weighted so that different sensors have different influences on the calculation of the object location. (The term “weighting” is intended to include the possibility of simply disregarding selected sensor outputs.) The weighting can be determined by various factors, such as the signal-to-noise ratios for the different sensors. Alternatively, the weighting can be altered in order to improve the quality of the resulting location estimate as indicated by the calculated angle between the metabearing lines. These are considered independent aspects of the invention, which are preferably, but not necessarily, used in conjunction with the techniques described above for performing the calculation of object location.

### BRIEF DESCRIPTION OF THE DRAWINGS

Arrangements embodying the invention will now be described by way of example with reference to the accompanying drawings, in which:

FIG. 1 is an example of a sensor network utilized to localize an object P₀ and to which the present invention can be applied.

FIG. 2 depicts an example showing how bearing lines can be represented.

FIG. 3 illustrates a representation in the (p,θ)-space of a bearing line passing through point P₀.

FIG. 4 depicts examples of bearing lines passing through point P₀.

FIG. 5 comprises FIG. 5a, illustrating schematically the representation of a point P₀ in the xy-plane by an ellipse obtained by cutting a unit-radius cylinder by a plane, and FIG. 5b, showing one cycle of a cosine wave obtained from the ellipse by unfolding the surface of the cylinder.

FIG. 6 shows four bearing lines and the acute angle between two metabearing lines.

FIG. 7 is a functional block diagram of a topologic correlator constructed in accordance with the invention.

FIG. 8 is a functional block diagram of a modified topologic correlator constructed in accordance with the invention.

FIG. 9 is a functional block diagram of a topologic correlator constructed in accordance with the invention and capable of processing bearing lines determined by sensors with different signal-to-noise ratio.

FIG. 10 is a functional block diagram of an example of a data fusion centre incorporating a topologic correlator constructed in accordance with the invention.

FIG. 11, comprising FIGS. 11a and 11b, depicts schematically examples of poor and more favourable ‘viewing’ geometry.

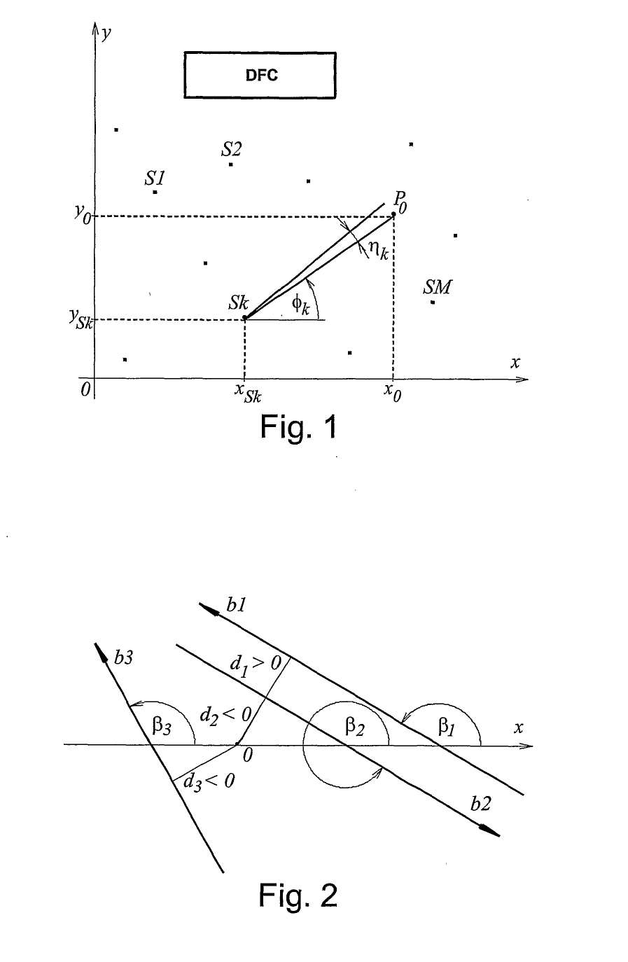

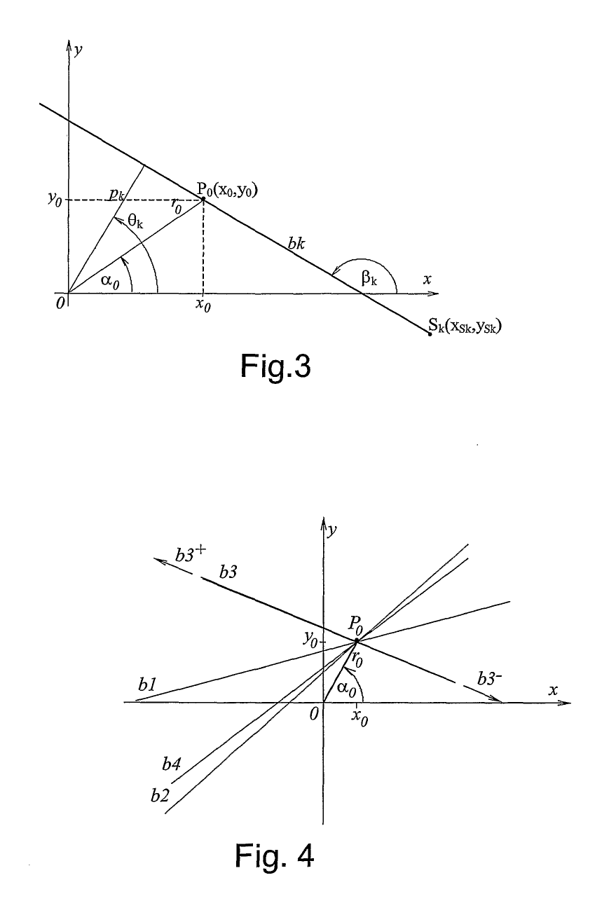

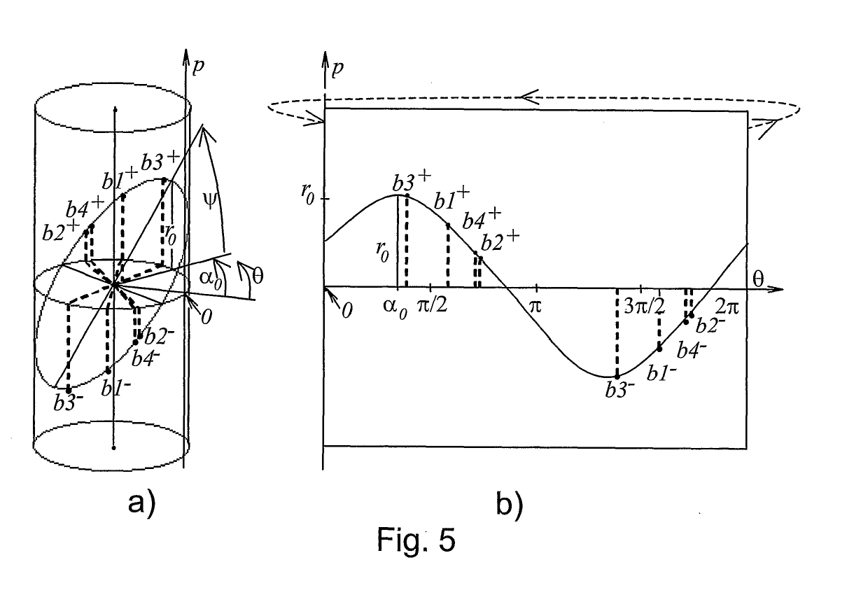

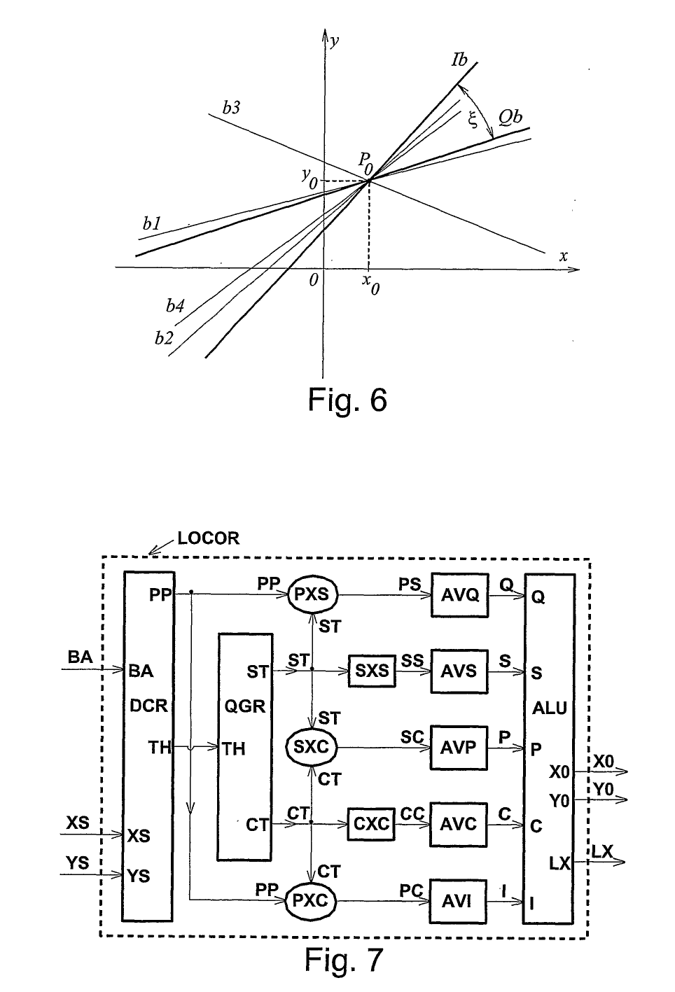

### DETAILED DESCRIPTION OF THE PREFERRED EMBODIMENTS

### First Embodiment

FIG. 7 is a functional block diagram of a topologic correlator LOCOR constructed in accordance with the invention. The correlator comprises a data converter DCR, a quadrature generator QGR, three multipliers: PXS, SXC and PXC, two squarers: SXS and CXC, five averagers: AVQ, AVS, AVP, AVC and AVI, and an arithmetic/logic unit ALU. As in other embodiments described below, all individual units can readily be constructed from hardware and/or software by anyone skilled in the art, given an understanding of the required functionality as set out in the present specification.

Bearing angles {βₖ; k=1, 2, . . . , M} obtained from M sensors are applied to an input BA, whereas the known coordinates {(x_{Sk}, y_{Sk}); k=1, 2, . . . , M} of the M sensors {Sk} are applied to inputs XS and YS of the converter DCR.

The converter processes jointly, according to equation (2), bearing angles {βₖ} and sensor coordinates {(x_{Sk}, y_{Sk})} to produce parameters {(pₖ, θₖ)} which represent respective bearing lines in the (p,θ)-space. The values TH of θₖ, appearing at output TH of the data converter DCR, are used by the quadrature generator QGR to produce at its respective outputs ST and CT values of sin θₖ and cos θₖ.

The values PP of pₖ, obtained at output PP of the data converter DCR, are multiplied in the multiplier PXS by the values ST of sin θₖ, and the resulting products (pₖ sin θk) are applied to input PS of the averager AVQ. Similarly, the values PP of Pk are multiplied in the multiplier PXC by the values CT of cos θₖ, and the resulting products (pₖ cos θₖ) are applied to input PC of the averager AVI.

The values ST and CT of sin θₖ and cos θₖ, supplied by the quadrature generator QGR, are also used by:
the multiplier SXC, to produce values SC of products (sin θₖ cos θₖ) to drive input SC of the averager AVP;
the squarer SXS, to produce values SS of sin² θₖ to drive input SS of the averager AVS;
the squarer CXC, to produce values CC of cos² θₖ to drive input CC of the averager AVC.

The values of averages Q, I, S, C and P are supplied by the respective averagers to the arithmetic/logic unit ALU that determines:
1. the values X0 and Y0 of the coordinates (x₀, y₀) of an object location, according to equation (8);
2. the value LX of the metabearing intersection angle ξ, according to equation (9); the value LX is indicative of the ‘goodness’ of the ‘viewing’ geometry.

The values X0, Y0 and LX are produced by the ALU at its respective outputs.

### Second Embodiment

Making use of the trigonometric identities
2 sin θ cos θ=sin 2θ, 2 cos² θ=1+cos 2θ, 2 sin²θ=1−cos 2θ
   leads to a significant modification of the topologic correlator LOCOR constructed in accordance with the method of the invention. Now, the three auxiliary averages, S, C and P, can be determined from

$$S = \frac{1 - CC}{2} , C = \frac{1 + CC}{2} , P = \frac{SS}{2} \qquad ( 10 )$$

where

$$CC \underline{Δ} \frac{1}{M} {\sum }_{k = 1}^{M} cos 2 {θ}_{k} , SS \underline{Δ} \frac{1}{M} {\sum }_{k = 1}^{M} cos 2 {θ}_{k}$$

In this implementation, no squaring circuits are needed, and the three auxiliary averages, S, C and P, can be obtained by employing only two averagers: one for cos 2θₖ and one for sin 2θₖ.

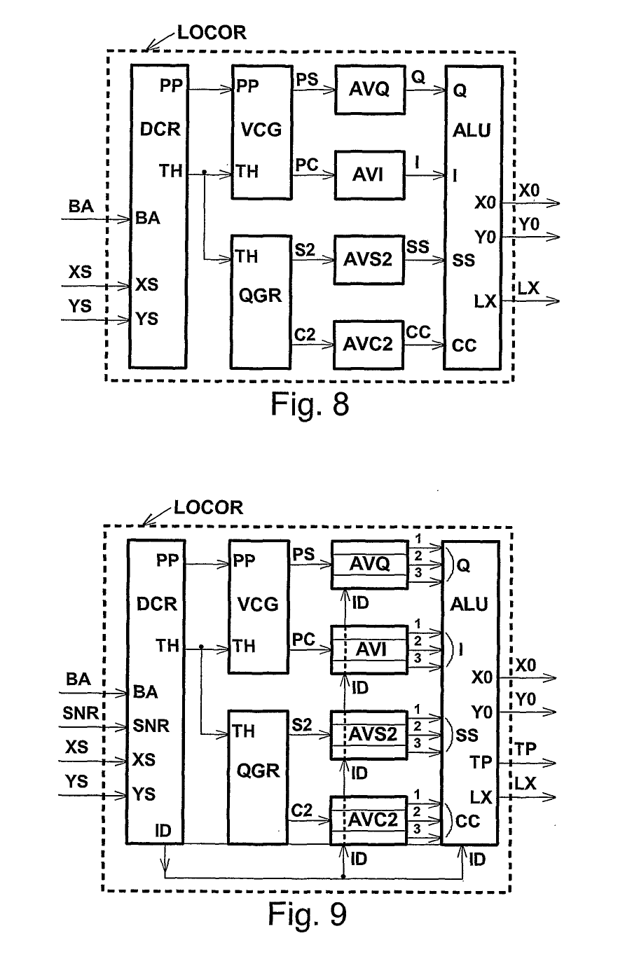

FIG. 8 is a functional block diagram of a modified topologic correlator LOCOR constructed in accordance with this embodiment of the invention. The correlator comprises a data converter DCR, a vector generator VCG, a quadrature generator QGR, four averagers: AVQ, AVI, AVS2 and AVC2, and an arithmetic/logic unit ALU.

Bearing angles {βₖ; k=1, 2, . . . , M} obtained from M sensors are applied to input BA, whereas the known coordinates {(x_{Sk}, y_{Sk}); k=1, 2, . . . , M} of the M sensors {Sk} are applied to inputs XS and YS of the converter DCR. The converter processes jointly, according to equation (2), bearing angles {βₖ} and sensor coordinates {(x_{Sk}, y_{Sk})} to produce parameters {(pₖ, θₖ)} which represent respective bearing lines in the (p,θ)-space.

The values TH of θₖ, appearing at output TH of the data converter DCR, are used by the quadrature generator QGR to produce at its respective outputs S2 and C2 values of sin 2θₖ and cos 2θₖ. The values appearing at outputs S2 and C2 are applied, respectively, to averagers AVS2 and AVC2.

The vector generator VCG produces directly at its two outputs, PS and PC, products (pₖ sin θₖ) and (pₖ cos θₖ) in response to values PP of pₖ and values TH of θₖ supplied by the data converter DCR at its respective outputs PP and TH.

The values appearing at outputs PS and PC are applied, respectively, to averagers AVQ and AVI.

The values of averagers Q, I, SS and CC are supplied by the respective averagers to the arithmetic/logic unit ALU that determines:
1. the values X0 and Y0 of the coordinates (x₀, y₀) of an object location, according to equations (8) and (10);
2. the value LX of the metabearing intersection angle ξ, according to equations (9) and (10); the value LX is indicative of the ‘goodness’ of the ‘viewing’ geometry.

The values X0, Y0 and LX are produced by the ALU at its respective outputs.

### Third Embodiment

In many practical cases, some information may be available regarding the accuracy with which the bearing angles {βₖ; k=1, 2, . . . , M} have been estimated. For example, each sensor Sk may supply a value gₖ of the observed signal-to-noise ratio (SNR) that affects the accuracy of angle determination. Such information can be utilized by arrangements of the present invention as follows:
1. The observed values gₖ of the signal-to-noise ratio are compared to a set of predetermined thresholds to form a number N of classes, each class being characterized by a different range of the SNR values. For example, three classes may be formed to indicate bearing observations at low SNR, moderate SNR or high SNR.
2. Parameters (pₖ, θₖ) obtained from reported bearing angles βₖ and known sensor locations (x_{Sk}, y_{Sk}) are used to form N groups. The parameters (pₖ, θₖ) will belong to the same group if the associated values gₖ of the signal-to-noise ratio fall into the same range of SNR values. For example, three groups may be formed; each group will comprise parameters obtained for the same range (low, moderate or high) of the SNR.
3. The parameters (pₖ, θₖ) within each group are then utilized to determine the coordinates (x₀, y₀) of the point P₀. As a result, there will be the same number N of coordinate pairs (x₀, y₀) as the number of groups. For example, in the case of three groups (i.e., three ranges of SNR values), the determined coordinates will be:
   (x₀, y₀)_{low}, (x₀, y₀)_{moderate}, (x₀, y₀)_{high}
4. The coordinates determined within each of N groups are then combined as follows:

$${x}_{0} = \frac{1}{W} {\sum }_{i = 1}^{N} {w}_{i} {x}_{0}^{( i )} , {y}_{0} = \frac{1}{W} {\sum }_{i = 1}^{N} {w}_{i} {y}_{0}^{( i )}$$

where

$${w}_{i} = {L}_{i} {g}_{i} , {\sum }_{i = 1}^{N} {w}_{i} = W$$

where x₀⁽ⁱ⁾, y₀⁽ⁱ⁾ are the calculated coordinates x₀, y₀ for each respective group i, Lᵢ is the number of observations falling in group i, and gᵢ is the average SNR for that group. Therefore, the product Lᵢgᵢ can be viewed as a total average power received by sensors belonging to the same group i, where i=1, 2, . . . , N.

As will be explained in more detail below, a similar averaging procedure may be applied to angles {ξ}.

FIG. 9 is a functional block diagram of a topologic correlator LOCOR constructed in accordance with the invention. The correlator comprises a data converter DCR, a vector generator VCG, a quadrature generator QGR, four blocks of averagers: AVQ, AVI, AVS2 and AVC2, and an arithmetic/logic unit ALU.

Bearing angles {βₖ; k=1, 2, . . . , M} together with values of the signal-to-noise ratio {gₖ; k=1, 2, . . . , M} are applied to inputs BA and SNR, respectively, whereas the known coordinates {(x_{Sk}, y_{Sk}); k=1, 2, . . . , M} of the M sensors {Sk} are applied to inputs XS and YS of the data converter DCR.

The data converter DCR processes jointly, according to equation (2), bearing angles {βₖ} and sensor coordinates {(x_{Sk}, y_{Sk})} to produce parameters {(pₖ, θₖ)} which represent respective bearing lines in the (p,θ)-space.

For each pair of parameters (pₖ, θₖ), the data converter DCR determines a group index ID depending on the value of the signal-to-noise ratio gₖ associated with the underlying bearing angle βₖ. The group index ID is an integer number, and its value is determined as follows:
ID=0, if gᵢ<SNRₜₕ₀, observation discarded
ID=1, if SNRₜₕ₀<gᵢ<SNRₜₕ₁, low-SNR observation
ID=2, if SNRₜₕ₁<gᵢ<SNRₜₕ₂, moderate-SNR observation
ID=3, if gᵢ>SNRₜₕ₂, high-SNR observation
   where SNRₜₕ₀, SNRₜₕ₁ and SNRₜₕ₂ are some predetermined suitably chosen threshold values.

The values TH of θₖ, appearing at output TH of the data converter DCR, are used by the quadrature generator QGR to produce at its respective outputs S2 and C2 values of sin 2θₖ and cos 2θₖ. The values appearing at outputs S2 and C2 are applied, respectively, to two blocks of averagers, AVS2 and AVC2.

The vector generator VCG produces directly at its two outputs, PS and PC, products (pₖ sin θₖ) and (pₖ cos θₖ) in response to values PP of pₖ and values TH of θₖ supplied by the data converter DCR at its respective outputs PP and TH. The values appearing at outputs PS and PC are applied, respectively, to two blocks of averagers AVQ and AVI.

Each of the four blocks of averagers, AVQ, AV1, AVS2 and AVC2, comprises three identical averagers, each corresponding to a specific (non-zero) value of the group index ID. A specific averager within each group will be assigned to the respective data input (PS, SS, S2 or C2) depending on the value of the index ID associated with the underlying bearing angle βₖ. As a result, each of four blocks of averagers has three outputs, each output corresponding to a different value of group index ID.

The four output values, Q, I, SS and CC, supplied by the averagers with the same (non-zero) index ID=i, where i=1, 2, 3, are utilized by the arithmetic/logic unit ALU to determine the coordinates (x₀⁽ⁱ⁾, y₀⁽ⁱ⁾) from

$${x}_{0}^{( i )} = \frac{{I}^{( i )} {S}^{( i )} - {Q}^{( i )} {P}^{( i )}}{{S}^{( i )} {C}^{( i )} - {[ {P}^{( i )} ]}^{2}} , {y}_{0}^{( i )} = \frac{{Q}^{( i )} {C}^{( i )} - {I}^{( i )} {P}^{( i )}}{{S}^{( i )} {C}^{( i )} - {[ {P}^{( i )} ]}^{2}}$$

Finally, the resulting coordinates (x₀, y₀) of an object being localized are determined by combining the coordinates {(x₀⁽ⁱ⁾, y₀⁽ⁱ⁾); i=1, 2, 3} as follows

$${x}_{0} = \frac{{w}_{1} {x}_{0}^{( 1 )} + {w}_{2} {x}_{0}^{( 2 )} + {w}_{3} {x}_{0}^{( 3 )}}{W} , {y}_{0} = \frac{{w}_{1} {y}_{0}^{( 1 )} + {w}_{2} {y}_{0}^{( 2 )} + {w}_{3} {y}_{0}^{( 3 )}}{W}$$

with W=w₁+w₂+w₃, and w₁=L1 G1, w₂=L2 G2, and w₃=L3 G3, where L1, L2 and L3 are the numbers of observations falling respectively into groups 1, 2 and 3, and G1, G2 and G3 are the average signal-to-noise ratios assigned to each corresponding group.

As a result, each weight wᵢ=Li Gi, i=1, 2, 3, can be viewed as a total average power received by sensors belonging to the same group. Also, the sum W of all the weights wᵢ is indicative of the total power received by the sensors employed for localization. The value W appears at the output TP of the arithmetic/logic unit ALU.

In a similar fashion, the four output values, Q, I, SS and CC, supplied by the averagers with the same (non-zero) index ID=i, where i=1, 2, 3, may be utilized by the arithmetic/logic unit ALU to determine the intersection angles ξ⁽ⁱ⁾ from

$${ξ}^{( i )} = arctan \vert \frac{{S}^{( i )} {C}^{( i )} - {[ {P}^{( i )} ]}^{2}}{{P}^{( i )}} \vert , i = 1 , 2 , 3$$

Then, the angles are combined as follows

$$ξ = \frac{{w}_{1} {ξ}^{( 1 )} + {w}_{2} {ξ}^{( 2 )} + {w}_{3} {ξ}^{( 3 )}}{W}$$

with W=w₁+w₂+w₃, and w₁=L1 G1, w₂=L2 G2, and w₃=L3 G3, where L1, L2 and L3 are the numbers of observations falling respectively into groups 1, 2 and 3, and G1, G2 and G3 are the average signal-to-noise ratios allocated to each corresponding group. The value LX of the average angle ξ appears at the output LX of the arithmetic/logic unit ALU.

The value LX indicates the quality of the estimate of the object location, based on the relative positions of the sensors and the object. If desired a suitable algorithm could be used to vary the weighting in accordance with the calculated value LX in order to improve the quality. In this situation the weighting would thus be a function of both (i) the SNR values for the respective sensors and (ii) their locations relative to each other and to the object. The weighting could instead be based on either one of these factors or on any other factor or combination of factors.

In some cases, it may be preferable not to apply angle averaging but utilize the determined angle values ξ⁽ⁱ⁾ for further processing.

Example of Incorporating a Topologic Correlator LOCOR into a Data Fusion Centre

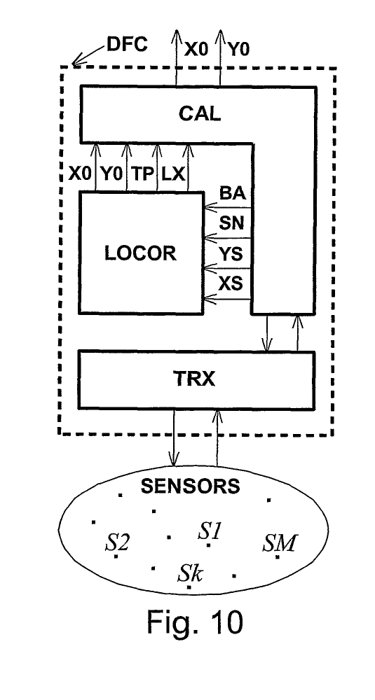

FIG. 10 is functional block diagram of a data fusion centre DFC incorporating a topologic correlator LOCOR constructed in accordance with the invention. The data fusion centre comprises a transceiver TRX, a topologic correlator LOCOR and a control/arithmetic/logic unit CAL. For the illustrative purposes, it is assumed that the third embodiment described above is employed as the correlator LOCOR, though with appropriate modifications either of the other embodiments could be used instead.

The control/arithmetic/logic unit CAL interrogates via the transceiver TRX a selected group of sensors {S} to obtain from them information on determined bearing angles and registered signal-to-noise ratios. This information, together with sensor coordinates, is passed to the topologic correlator LOCOR via internal links BA, SN, YS and XS for further processing.

The correlator LOCOR determines the object location, the total power of signals received by the sensors and the angle of intersection of metabearing lines. This information is sent to the unit CAL via internal links X0, Y0, TP and LX.

In bearings-only object localization, the selection of a group of sensors by the DFC for surveillance purposes could be based on two main criteria:
1. a sufficiently high level of power of signals intercepted by the group;
2. a favourable ‘viewing geometry’ of an object under surveillance, as determined by measuring the angle ξ of intersection of metabearing lines.

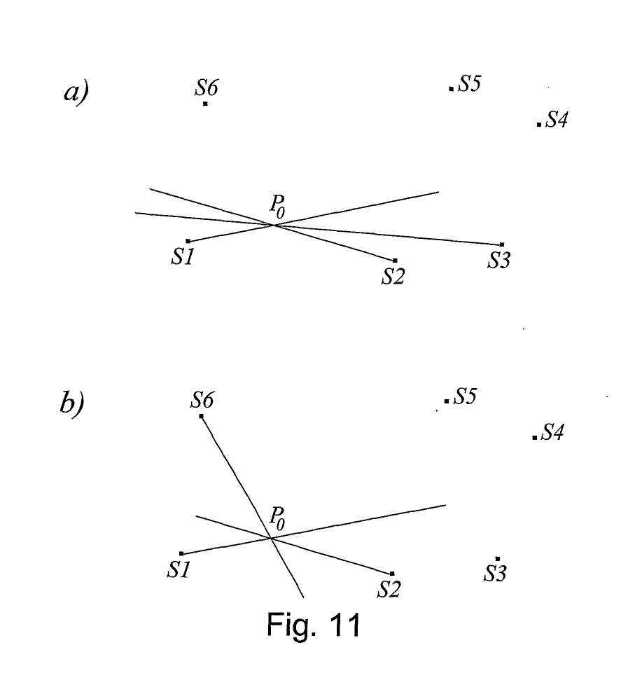

Therefore, if the control/arithmetic/logic unit CAL decides that the total power is too low and/or the ‘viewing geometry’ is not favourable, it will attempt to form a new group of sensors. Some ‘old’ sensors may be retained and new sensors may be added. Then, the performance of the new group will be assessed on the basis of the total received power and the ‘viewing’ geometry. As an example, the ‘viewing’ geometry depicted in FIG. 11a is poor, whereas the ‘viewing’ geometry obtained by replacing sensor S3 by sensor S6 is more favourable, as seen from FIG. 11b.

In the preceding discussion, the SNR values of the sensors are used to indicate the quality of the bearing measurements and hence they form bearing error values used for weighting the effect of the bearing measurement and/or the selection of sub-sets of sensors. However, other factors could be used instead of or as well as the SNR values (for example values representing potential quantisation errors).

The foregoing description of preferred embodiments of the invention has been presented for the purpose of illustration and description. It is not intended to be exhaustive or to limit the invention to the precise form disclosed. In light of the foregoing description, it is evident that many alterations, modifications, and variations will enable those skilled in the art to utilize the invention in various embodiments suited to the particular use contemplated.

1-17. (canceled)

18. A method of determining the location of an object using data representing a set of bearing lines of the object from a plurality of known observation locations, the method comprising:
for each bearing line, deriving the coordinates of a point which represents the bearing line, the coordinates comprising a first coordinate representing the distance from a reference location to the closest point on the bearing line, and a second coordinate representing the angle of the bearing line with respect to a reference direction, using a mapping procedure according to which the coordinates indicate the direction of the bearing line; and
deriving parameters defining a cosine curve substantially fitting said points, said parameters representing the object location.

19. A method as claimed in claim 18, wherein the parameters representing the object location are derived by:
for each point, deriving first and second components by transforming the respective coordinates using, respectively, first and second orthogonal functions;
deriving a first quantity I by combining the first components and a second quantity Q by combining the second components; and
determining the intersection of the lines represented by
Px+Sy−Q=0
Cx+Py−I=0
wherein x, y are Cartesian coordinates and C, S and P are proportional to the averages of the following quantities, respectively:
cos² θ
sin² θ
sin θ cos θ
where θ is the second coordinate.

20. A method of determining the location of an object using data representing a set of bearing lines of the object from a plurality of known observation locations, the method comprising:
for each bearing line, deriving the coordinates of a point which represents the bearing line, the coordinates comprising a first coordinate representing the distance from a reference location to the closest point on the bearing line, and a second coordinate representing the angle of the bearing line with respect to a reference direction, using a mapping procedure according to which the coordinates indicate the direction of the bearing line;
for each point, deriving first and second components by transforming the respective coordinates using, respectively, first and second orthogonal functions;
deriving a first quantity I by combining the first components and a second quantity Q by combining the second components; and
determining the intersection of the lines represented by
Px+Sy−Q=0
Cx+Py−I=0
wherein x, y are Cartesian coordinates and C, S and P are proportional to the averages of the following quantities, respectively:
cos² θ
sin² θ
sin θ cos θ
where θ is the second coordinate.

21. A method as claimed in claim 19, including the step of determining the angle between the lines represented by said equations, the angle being indicative of the viewing geometry of the bearing lines.

22. A method as claimed in claim 19, wherein the reference direction is parallel to one of the Cartesian axes.

23. A method as claimed in claim 18, wherein the mapping procedure is such that the first coordinate is the signed distance between the reference location and the closest point on the bearing line.

24. A method as claimed in claim 18, wherein the mapping procedure is such that co-linear bearings of opposite direction have second coordinates which differ from each other by π.

25. A method according to claim 18, including the steps of deriving plural sets of coordinates each representing the object location calculated from data representing a respective group of bearings, and combining the sets in a weighted manner to derive a resultant set of coordinates representing the object location.

26. A method as claimed in claim 25, including the step of allocating the bearings to respective groups in accordance with bearing error values representing characteristics associated with the measurements of the bearings.

27. A method as claimed in claim 26, wherein the bearing error values represent signal-to-noise characteristics of the measurements of the bearings.

28. A method as claimed in claim 25, including the step of allocating the bearings to respective groups in accordance with the relationships between the bearing lines.

29. A method as claimed in claim 28, including the steps of:
determining the angle between the lines represented by said equations, the angle being indicative of the viewing geometry of the bearing lines; and
using said angle between the lines represented by said equations to represent the relationships between the bearing lines.

30. A method according to claim 18, including the step of measuring viewing geometry parameters determined by the relationships between groups of bearing lines, selecting a sub-set of said observation locations according to said measured geometry parameters and deriving a set of coordinates representing the object location from data representing the bearing of the object from each of the observation locations of said sub-set.

31. A method as claimed in claim 30, including the step of measuring a geometry parameter by determining said angle between the lines represented by said equations, the angle being indicative of the viewing geometry of the bearing lines.

32. A method of determining the location of an object using data representing a set of bearing lines of the object from a plurality of known observation locations, the method comprising measuring viewing geometry parameters determined by the relationships between groups of bearing lines, selecting a sub-set of said observation locations according to said measured geometry parameters and deriving a set of coordinates representing the object location from data representing the bearing of the object from each of the observation locations of said sub-set.

33. A method as claimed in claim 30, wherein the step of selecting said sub-set also takes into account bearing error values representing characteristics associated with the measurements of the bearings.

34. A method as claimed in claim 33, wherein the bearing error values represent signal-to-noise characteristics of the measurements of the bearings.

35. Apparatus for determining the location of an object using data representing a set of bearing lines of the object from a plurality of known observation locations, the apparatus being arranged to operate according to a method as claimed in any preceding claim.

36. Apparatus as claimed in claim 35, including a network of distributed sensors for generating data representing said bearing lines.
